(19) United States
(12) Patent Application Publication
(10) Pub. No.: US 2003/0086769 A1
(43) Pub. Date: May 8, 2003

(54) Apparatus and methods for producing a curved tooth

(76) Inventor: Gregory A. Hyatt, Ligonier, PA (US)

Correspondence Address: DINSMORE & SHOHL, LLP, 1900 CHEMED CENTER, 255 EAST FIFTH STREET, CINCINNATI, OH, 45202, US

(21) Appl. No.: 10/245,774

(22) Filed: Sep. 17, 2002

Related U.S. Application Data
(60) Provisional application No. 60/323,041, filed on Sep. 17, 2001.

(51) Int. Cl. B23C 3/32; B23F 13/00; B26D 3/06

(52) U.S. Cl. 409/76; 409/66; 409/138; 83/875

(57) ABSTRACT

Methods and apparatus are provided for producing a curved tooth. Apparatus are adapted to perform a method that includes the steps of providing a workpiece, providing a tool, and providing relative movement between the tool and the workpiece such that the tool moves along a first curved path relative to the workpiece to define a first curved surface of a tooth in the workpiece. The relative movement can be accomplished by substantially simultaneous translation of at least one of the tool and the workpiece along a first linear axis and a second linear axis that is perpendicular to the first linear axis. Methods are also disclosed for compensating for deviations in a tool path.

### REFERENCE TO RELATED APPLICATIONS

This application claims the benefit of U.S. Provisional Application No. 60/323,041 filed Sep. 17, 2001.

### TECHNICAL FIELD OF THE INVENTION

The present invention is directed to apparatus and methods for machining a workpiece, and in particular, apparatus and methods for producing a curved tooth.

### BACKGROUND OF THE INVENTION

Machines and processes are known to assist in forming longitudinally curved teeth in a workpiece. For example, U.S. Pat. No. 4,780,990 to Cody, Jr. et al. discloses a method and machine for forming longitudinally curved tooth surfaces. In order to create the curved tooth, a dish-shaped grinding wheel is rotated about its axis and oscillated about a cradle axis. There is a continuing need for methods and apparatus to produce one or more curved teeth.

### SUMMARY OF THE INVENTION

Accordingly, it is an object of the present invention to obviate problems and shortcomings of conventional methods and apparatus for machining a workpiece, and in particular, apparatus and methods for producing a curved tooth.

To achieve the forgoing and other objects and in accordance with the present invention, methods are disclosed for producing a curved tooth comprising the steps of providing a workpiece, providing a tool, and providing relative movement between the tool and the workpiece such that the tool moves along a first curved path relative to the workpiece to define a first curved surface of a tooth in the workpiece. The relative movement is accomplished by substantially simultaneous translation of at least one of the tool and the workpiece along a first linear axis and a second linear axis that is perpendicular to the first linear axis.

To achieve further objects and in accordance with the present invention, methods of producing a curved tooth are disclosed comprising the steps of providing a workpiece, providing a tool, and moving the tool through a tool path by rotating the tool about a path-defining axis to define a first curved surface of a tooth in the workpiece. The first curved surface is defined about a first axis of curvature, and the path-defining axis substantially extends along the first axis of curvature. The methods of producing a curved tooth further comprise the steps of mapping deviations between the path-defining axis and the axis of curvature while moving the tool through the tool path and compensating for mapped deviations by modifying the tool path.

To achieve still further objects and in accordance with the present invention, an apparatus for producing a curved tooth in a workpiece are disclosed. The apparatus comprise a tool and a device provided with instructions for providing relative movement between the tool and the workpiece such that the tool is capable of moving along a first curved path relative to the workpiece to define a first curved surface of a tooth in the workpiece. The instructions assist in generating the first curved path by directing substantial simultaneous translation of at least one of the tool and the workpiece along a first linear axis and a second linear axis that is perpendicular to the first linear axis.

To achieve yet additional objects and in accordance with the present invention apparatus are also disclosed for producing a curved tooth having a first curved surface defined about a first axis of curvature. The apparatus comprises a tool and a device for moving the tool, wherein the device is provided with instructions for moving the tool through a tool path by rotating the tool about a path-defining axis to define a first curved surface of a tooth. The device is adapted to map deviations between the path-defining axis and the axis of curvature while the tool is moving through the tool path. The device is also adapted to compensate for the mapped deviations by modifying the tool path.

Still other embodiments, structural combinations, advantages and objects of the present invention will become apparent to those skilled in the art from the following description wherein there are shown and described alternative exemplary embodiments of this invention for illustration purposes. As will be realized, the invention is capable of other different, obvious aspects, objects and embodiments, all without departing from the scope of the invention. Accordingly, the drawings, objects and descriptions should be regarded as illustrative and exemplary in nature only, and not as restrictive.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a sectional view of one exemplary conventional workpiece;

FIG. 2 is a sectional view of another exemplary conventional workpiece;

FIG. 3 is a front elevational view of an exemplary apparatus in accordance with the present invention;

FIG. 4 is a partial sectional view of the device of FIG. 3 for defining a curved surface of a tooth;

FIG. 5 is a front elevational view of another exemplary apparatus in accordance with another exemplary embodiment of the present invention;

FIG. 6 is sectional view along line 6-6 of FIG. 5;

FIG. 7 is a front elevational view of yet another exemplary apparatus in accordance with another exemplary embodiment of the present invention;

FIG. 8 is sectional view along line 8-8 of FIG. 7;

FIG. 9A illustrates a partial sectional view along line 9-9 of FIG. 4 wherein the machine surface of the tool is following the first curved tool path in an initial position to define a first outwardly concave curved surface;

FIG. 9B illustrates a partial sectional view along line 9-9 of FIG. 4 wherein the machine surface of the tool is following the first curved tool path in an intermediate position to define a first outwardly concave curved surface;

FIG. 9C illustrates a partial sectional view along line 9-9 of FIG. 4 wherein the machine surface of the tool is following the first curved tool path in a final position to define a first outwardly concave curved surface;

FIG. 9D illustrates a partial sectional view along line 9-9 of FIG. 4 wherein the machine surface of the tool is following the first curved tool path in an initial position to define a first outwardly convex curved surface;

FIG. 9E illustrates a partial sectional view along line 9-9 of FIG. 4 wherein the machine surface of the tool is following the first curved tool path in an intermediate position to define a first outwardly convex curved surface;

FIG. 9F illustrates a partial sectional view along line 9-9 of FIG. 4 wherein the machine surface of the tool is following the first curved tool path in a final position to define a first outwardly convex curved surface; and

FIG. 10 is a partial perspective view of an exemplary apparatus in accordance with the present invention defining a curved surface of a tooth.

### DETAILED DESCRIPTION OF EXEMPLARY EMBODIMENTS

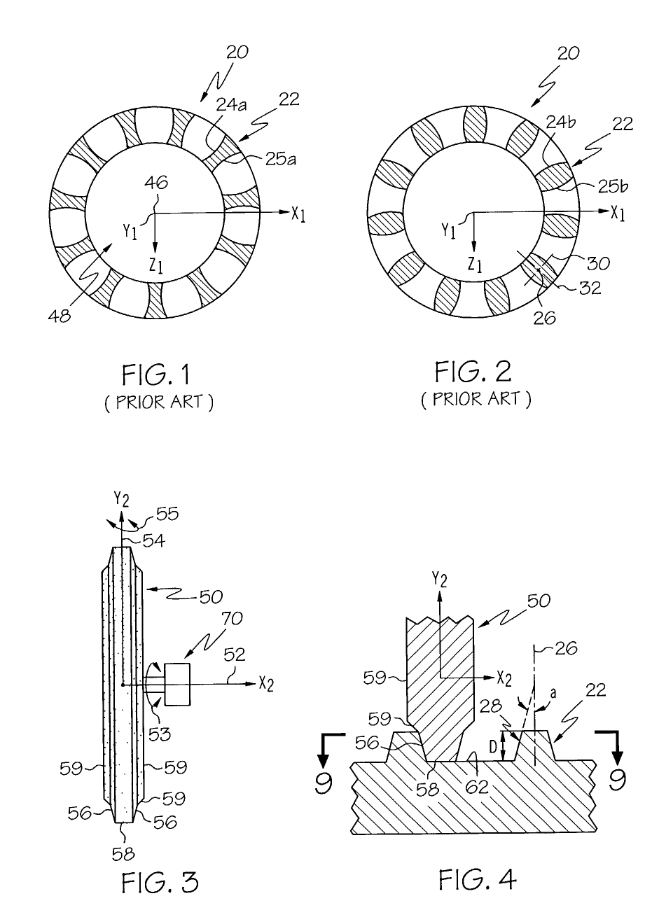

Referring now to the drawing figures in detail, where like numerals indicate the same elements throughout the views, FIGS. 1 and 2 depict a conventional workpiece 20 may include a plurality of teeth 22 arranged radially about the central axis 46 of the workpiece 20. The workpiece may further include a central cavity, or through opening 48. As illustrated in FIGS. 1 and 2, the workpiece is in the form of coupling members that are adapted to be coupled with one another. For example, the teeth 22 of the workpiece 20 of FIG. 1 are each illustrated with a first outwardly concave curved surface 24a and a second outwardly concave curved surface 25a. In another example as illustrated by the workpiece 20 in FIG. 2, the teeth 22 may include a first outwardly convex curved surface 24b and a second outwardly convex curved surface 25b. It is understood that the number of teeth and diameter of the workpiece are illustrative in nature. For example, the workpieces may include a substantially larger or smaller diameter with a substantially different number of teeth. Moreover, the concave and convex surfaces characteristics are illustrative in nature and, for example, might include a significantly larger or smaller radius of curvature.

While the concepts of the present invention may be used with coupling members, it is understood that the concepts of the present invention may be applied to generate a curved tooth in a variety of applications. Moreover, the surfaces of the teeth may include a variety of shapes. For example, the surfaces could include one or more two or three dimensional surfaces such as frustoconical surfaces, flat surfaces, random surfaces, wave surfaces, angled surfaces or the like.

FIG. 3 depicts a first exemplary tool 50 in accordance with the present invention in the form of a grinding wheel, wherein the tool 50 is attached to a device 70. The device 70 may be provided with instructions in accordance with the present invention to direct the movement of the grinding wheel. For example, the instructions might take the form of a mechanical instructions, computer instructions, instructions contained on a flash card, instructions contained in system memory, random access memory, or the like.

The device 70 is adapted to rotate the grinding wheel about a tool rotation axis 52 in at least one rotational direction indicated by the double arrow 53. The rotational axis 52 extends along the first tool axis X₂ (as illustrated in FIG. 3) or is parallel to the first tool axis X₂. Moreover, in some embodiments of the present invention, the tool 50 may be rotated about a yaw axis 54 in at least one direction indicated by the double arrow 55. The yaw axis 54 extends along the third tool axis Y₂ (as illustrated in FIG. 3) or is parallel to the third tool axis Y₂.

The grinding wheel may include a machine surface 56 for defining the curved surface of the tooth 22 and another machine surface 58 for removing material between adjacent teeth to define the depth “D” of the tooth 22 and to further define a base surface 62 of the workpiece. The grinding wheel may further include additional material 59 to provide the tool with increased structural integrity. It is understood that the wheel may be resurfaced or replaced in a conventional manner known in the art when the tool becomes worn or damaged to maintain the tooth parameters within an acceptable tolerance range.

FIG. 4 depicts a partial sectional view of the device of FIG. 3 defining a curved surface of a tooth 22. The curved surface of the tooth includes a cross-sectional profile 28 along a cross-sectional profile plane 30. In one example, the cross-sectional profile 28 extends at an angle “a” of approximately 30° relative to the tooth axis 26 of the tooth 22. It is understood, however, that apparatus and methods in accordance with the present invention may be used to generate a wide range of angles “a” depending on the particular application and that the 30° angle is therefore exemplary in nature and should not be viewed as restrictive.

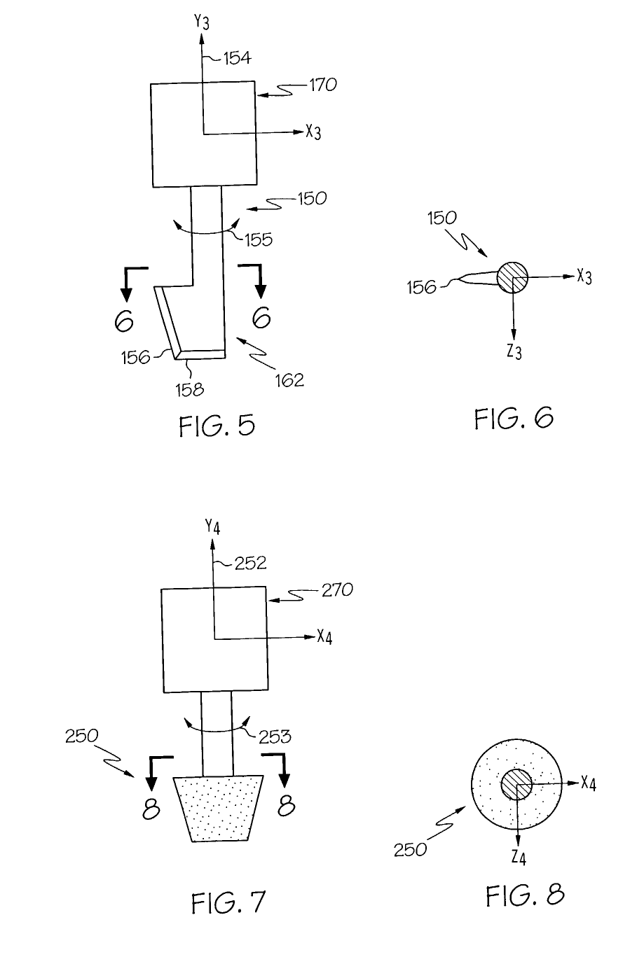

FIGS. 5 and 6 illustrate another exemplary apparatus in accordance with another exemplary embodiment of the present invention including a cutter tool 150, such as a shaping, milling or planing cutter tool. In one example, as illustrated in FIG. 5, the cutter comprises a blade 162 including a machining surface 156 for defining the curved surface of the tooth 22 and another machine surface 158 for removing material between adjacent teeth to define the depth “D” of the tooth 22 and to further define a base surface 62 of the workpiece. The cutter tool 150 is attached to a device 170. The device 170 may be provided with instructions in accordance with the present invention to control the movement of cutter tool 150. In some embodiments, the device 170 may rotate the tool 150 about a yaw axis 154 in at least one direction indicated by the double arrow 155. The yaw axis 154 extends along the third tool axis Y₃ (as illustrated in FIG. 5) or is parallel to the third tool axis Y₃. In other embodiments, the tool is not rotated about the yaw axis 154 when the tool 150 is producing the curved surface of the tooth.

FIGS. 7 and 8 illustrate yet another exemplary apparatus in accordance with another exemplary embodiment of the present invention including a tool without a yaw axis. Rather, the tool comprises a grinding tool 250 attached to a device 270 for rotating about a tool rotation axis 252. The device 270 may be provided with instructions in accordance with the present invention to direct the movement of the grinding tool 250. The device 270 is adapted to rotate the grinding tool 250 about a tool rotation axis 252 in at least one rotational direction indicated by the double arrow 253. The rotational axis 252 extends along the third tool axis Y₄ (as illustrated in FIG. 7) or is parallel to the third tool axis Y₄.

In still another embodiment, the cutter tool 250 of FIGS. 7-8 could be rotated about a rotation axis, previously defined as the yaw axis 154, such that the blade planes or mills the surface as the cutter tool 250 rapidly rotates about the rotational axis. In this embodiment, additional blades 156 could be provided and radially arranged about the rotational axis to facilitate the milling or planing action of the cutter tool. It will be understood that the blade shape 156 could be modified as desired to enhance material removal in accordance with the present invention.

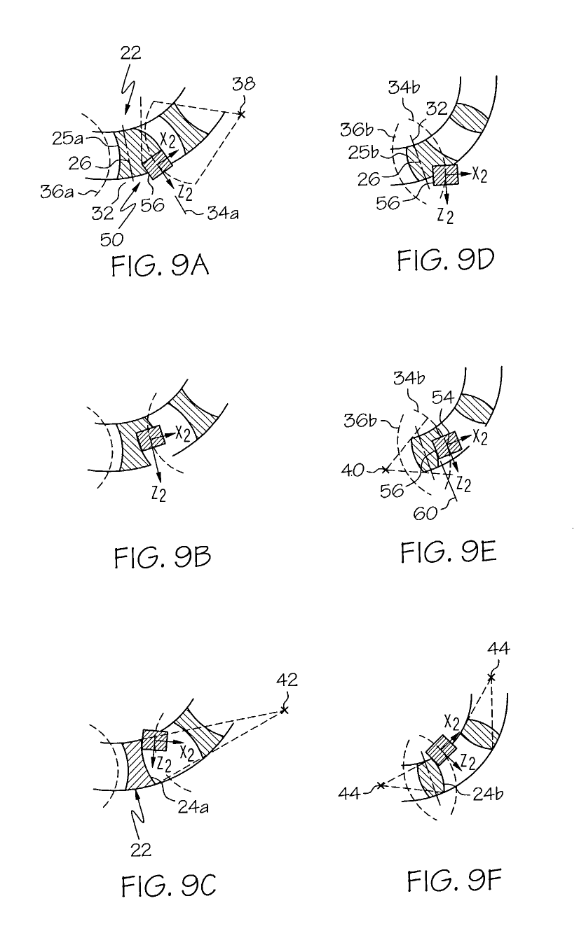

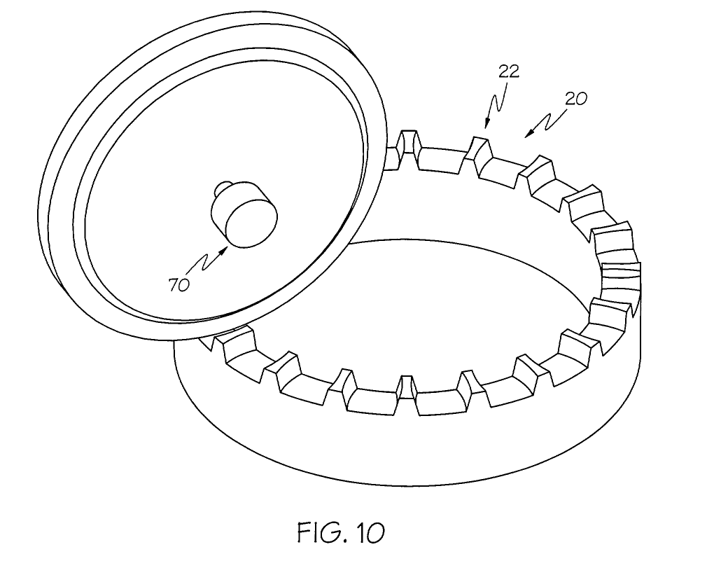

FIGS. 9A-9F are partial sectional views taken generally along line 9-9 of FIG. 4 to illustrate exemplary embodiments of methods for defining a curved tooth surface, wherein a partial perspective view of the grinding wheel 50 attached to the device 70 is illustrated in FIG. 10.

The device 70, as well as the devices 170 and 270, includes at least a portion of a machine that may be of the type generally known as a computer numerically controlled (“CNC”) machine which permits various tool manipulations along a plurality of rotational and linear axis, for machining, such as grinding, milling, planing, cutting, honing, boring, polishing or other machining operations wherein at least a portion of the material from a workpiece is removed. The CNC machine permits a wide range and potentially unlimited tool orientation with respect to the workpiece for performing various machining operations. The device (e.g., 70, 170, 270) may be provided with instructions for operating and controlling the tool orientation relative to the workpiece throughout the machining operation to define the curved tooth. For example, as described above, the device 70 may be provided with instructions for moving the tool 50 along a first curved path 34a to define a first curved surface 24a of a tooth 22 in a workpiece 20. The instructions might include commands to generate the first curved path 34a by directing substantial simultaneous translation of the tool 50 along the first linear axis X₁ and the second linear axis Z₁.

It will be understood that the instructions could direct the movement of the tool 50 along a second curved tool path 36a to define a second outwardly concave curved surface 25a. In one exemplary embodiment, the instructions are capable of direction the tool 50 to move along the second curved path 36a that is a substantial mirror image of the first curved path 34a, for example, relative to a mirror image plane 32. Providing mirror image tool paths provides a curved tooth with the second outwardly concave curved surface 25a being a mirror image of the first outwardly concave curved surface 24a with respect to a mirror image plane 32 including the tooth axis 26.

FIGS. 9A-9C, illustrate a process of defining a first outwardly concave curved surface 24a of a tooth 22 by moving the tool 50 along a first curved tool path 34a. Movement of the tool includes substantially simultaneous translation of the tool along the first linear axis X₁ (see FIG. 1) and the second linear axis Z₁. The tooth 22 extends along a tooth axis 26 and the tool 50 defines the first outwardly concave curved surface 24a relative to the tooth axis 26.

As illustrated in FIG. 9A, the machine surface 56 of the tool 50 follows the first curved tool path 34a in an initial position to begin to defined the first outwardly concave curved surface 24a. FIG. 9B illustrates the tool 50 following the first curved tool path 34a in an intermediate position to further define the first outwardly concave curved surface 24a. FIG. 9C illustrates the tool 50 continuing to follow the first curved tool path 34a in a final position to complete the formation of the first outwardly concave curved surface 24a. It will be understood that the above process may be performed to guide the tool 50 along the second tool path 36a to define the second outwardly concave curved surface 25a.

The tool 50 may also define the first and second outwardly concave curved surfaces by rotating the tool about a path defining axis. The device 70 may alternatively, or in addition, be provided with instructions for moving the tool 50 through a tool path by rotating the tool about a path-defining axis. For example, the device 70 may include instructions for moving the tool 50 through a first curved tool path 34a by rotating the tool 50 about a path-defining axis 38 to define a first outwardly concave curved surface 24a. The device 70 may also be designed to map deviations between the path-defining axis 38 and an axis of curvature 42 of the first outwardly concave curved surface 24a. The device could be adapted to compensate for the mapped deviations between the path-defining axis 38 and the axis of curvature 42 by modifying the tool path. For example, the device 70 may include a command for comparing the locations of the axis of curvature and the path-defining axis to move the tool such that the path-defining axis substantially extends along the axis of curvature. It is understood that the above mentioned process could be repeated to define the second outwardly concave curved surface.

FIGS. 9D-9F, illustrate a process of defining a first outwardly convex curved surface 24b of a tooth 22 by moving the tool 50 along a first curved tool path 34b. Movement of the tool includes substantially simultaneous translation of the tool along the first linear axis X₁ (see FIG. 1) and the second linear axis Z₁. The tooth 22 extends along a tooth axis 26 and the tool 50 defines the first outwardly convex curved surface 24b relative to the tooth axis 26.

As illustrated in FIG. 9D, the machine surface 56 of the tool 50 follows the first curved tool path 34a in an initial position to begin to defined the first outwardly convex curved surface 24b. FIG. 9E illustrates the tool 50 following the first curved tool path 34b in an intermediate position to further define the first outwardly convex curved surface 24b. As further illustrated in FIG. 9E, the tool 50 may optionally be rotated about yaw axis 54 to substantially maintain the machining surface 56 along a plane of tangency 60 to the first outwardly convex curved surface 24b while the tool 50 is defining the first outwardly convex curved surface 24b of the tooth 22. FIG. 9F illustrates the tool 50 continuing to follow the first curved tool path 34b in a final position to complete the formation of the first outwardly convex curved surface 24b. It will be understood that the above process may be performed to guide the tool 50 along the second tool path 36b to define the second outwardly convex curved surface 25b.

The tool 50 may also define the first and second outwardly convex curved surfaces by rotating the tool about a path defining axis. The device 70 may alternatively, or in addition, be provided with instructions for moving the tool 50 through a tool path by rotating the tool about a path-defining axis. For example, the device 70 may include instructions for moving the tool 50 through a first curved tool path 34b by rotating the tool 50 about a path-defining axis 40 to define a first outwardly convex curved surface 24b. The device 70 may also be designed to map deviations between the path-defining axis 40 and an axis of curvature 44 of the first outwardly convex curved surface 24b. The device could be adapted to compensate for the mapped deviations between the path-defining axis 40 and the axis of curvature 44 by modifying the tool path. For example, the device 70 may include a command for comparing the locations of the axis of curvature and the path-defining axis to move the tool such that the path-defining axis substantially extends along the axis of curvature. It is understood that the above mentioned process could be repeated to define the second outwardly convex curved surface.

It will be understood that the width of the machining surface 58 could be selected to be sufficiently wide such that the machining width of the curved tool paths used to generate facing curve surfaces from corresponding adjacent teeth (e.g., when defining the teeth 22 illustrated in FIGS. 1 and 2) could overlap sufficiently to completely remove the desired amount of material between the adjacent teeth. It is also understood that the device 70 could also include instructions to direct the tool along additional tool paths to finish the machining of material from between adjacent teeth.

The examples illustrated in FIGS. 9A-9F illustrate the tool 50 rotating about the yaw axis 54, for example, to minimize interference between the tool and the tooth. Moreover, if a grinding wheel 50 is used, the diameter of the grinding wheel should be sufficiently small to minimize interference with the tooth as the curved tooth is being produced. If a sufficiently small diameter grinding wheel is used, rotation of the tool 50 about the yaw axis may not be necessary. However, the tool 50 could be rotated about the yaw axis 54 to minimize interference between the tool and the tooth when using grinding wheels of increased diameter. Moreover, it is understood that the diameter of the grinding wheel tool could be selected below the radius of the curvature of the concave tooth, by a factor dependent upon the radius of the tooth, the height of the tooth, and the angle of the tooth, to reduce or eliminate the interference between the grinding wheel and portions of the tooth.

It will be understood that the rotation of the tool about the yaw axis may occur in intermittent steps as the tool is translated along the first and second linear axis. In other embodiments, the tool is substantially simultaneously rotated about the yaw axis as the tool is translated along the first and second linear axes. In still additional embodiments, the tool is substantially continuously rotated about the yaw axis while the tool is translating along the first and second linear axes.

In still further embodiments of the invention, the tool (e.g., 50, 150, 250, etc.) could be used to produce a curved tooth without rotating the tool about the yaw axis. This may prove to be particularly effective where the machining surface is minimized. For example, the machining surface 56 of the grinding wheel 50 could be minimized by reducing the overall diameter of the grinding wheel. In still further examples, the machining surface may be minimized due to the inherent characteristics of the tool machining surface. For instance, as illustrated in FIG. 5, the machining surface 156 of the blade 162 may comprise a machining surface in the form of a cutting edge such that relative rotation of the tool about the yaw axis may not be necessary to effectively produce the curved tooth.

While the apparatus and processes above describe the device moving the tool, it is understood that other embodiments of the present invention might involve the device moving the workpiece relative to the tool or moving both the tool and the workpiece relative to one another. In each of the above exemplary embodiments, relative movement (e.g., translational, rotational, etc.) between the tool and the workpiece is achieved.

It is understood that while many of the processes described above describe the use of a device 70 and tool 50, the processes above could be used with the other devices and tools described throughout the application including the devices 170, 270 and the tools 150, 250.

The foregoing description of the various embodiments of the invention has been presented for the purposes of illustration and description. It is not intended to be exhaustive or to limit the invention to the precise form disclosed. Many alternatives, modifications and variations will be apparent to those skilled in the art of the above teaching. Accordingly, this invention is intended to embrace all alternatives, modifications and variations that have been discussed herein, and others that fall within the spirit and broad scope of the claims.

What is claimed is:

1. A method of producing a curved tooth comprising the steps of:
a) providing a workpiece;
b) providing a tool;
c) providing relative movement between the tool and the workpiece such that the tool moves along a first curved path relative to the workpiece to define a first curved surface of a tooth in the workpiece, wherein the relative movement is accomplished by substantially simultaneous translation of at least one of the tool and the workpiece along a first linear axis and a second linear axis that is perpendicular to the first linear axis.

2. The method of claim 1, wherein the tooth extends along a tooth axis and wherein the first curved surface is defined relative to the tooth axis.

3. The method of claim 2, further comprising the step of providing relative movement between the tool and the workpiece along a third linear axis that is substantially parallel to the tooth axis to define a depth of the tooth.

4. The method of claim 2, wherein the first curved surface is outwardly convex with respect to the tooth axis.

5. The method of claim 2, wherein the first curved surface is outwardly concave with respect to the tooth axis.

6. The method of claim 2, wherein the first curved surface includes a cross sectional profile along an imaginary cross sectional plane passing through the tooth axis, and wherein the cross sectional profile extends at an angle of approximately 30° relative to the tooth axis.

7. The method of claim 2, comprising the further step of providing further relative movement between the workpiece and the tool such that the tool moves along a second curved path relative to the workpiece to define a second curved surface of a tooth in the workpiece.

8. The method of claim 7, wherein the tooth axis extends along an imaginary mirror image plane and wherein the second curved surface is a substantial mirror image of the first curved surface with respect to the imaginary mirror image plane.

9. The method of claim 8, wherein the first and second curved surfaces are outwardly convex with respect to the tooth axis.

10. The method of claim 8, wherein the first and second curved surfaces are outwardly concave with respect to the tooth axis.

11. The method of claim 7, wherein the first and second curved surfaces each include a cross sectional profile along an imaginary cross sectional plane passing through the tooth axis, and wherein each cross sectional profile extends at an angle of approximately 30° relative to the tooth axis.

12. The method of claim 2, wherein the tool includes a yaw axis that is substantially parallel to the tooth axis and further comprising the step of rotating the tool about a tool rotation axis that is substantially perpendicular to the yaw axis.

13. The method of claim 2, further comprising the step of providing relative rotation between the tool and the workpiece about a yaw axis that is substantially parallel to the tooth axis.

14. The method of claim 13, wherein the tool includes the yaw axis and wherein the step of providing relative rotation includes rotating the tool about the yaw axis.

15. The method of claim 13, wherein the step of providing relative movement between the tool and the workpiece includes substantially simultaneous relative rotation between the tool and the workpiece about the yaw axis as at least one of the tool and the workpiece is translated along the first and second linear axes.

16. The method of claim 13, wherein the relative rotation between the tool and the workpiece occurs substantially continuously while at least one of the tool and the workpiece is translating along the first and second linear axes.

17. The method of claim 13, wherein the tool includes a machining surface and wherein the relative rotation about the yaw axis substantially maintains the machining surface along a plane that is tangent to the curved surface while the tool is defining the first curved surface of the tooth.

18. The method of claim 13, wherein the relative rotation about the yaw axis minimizes interference between the tool and the tooth.

19. The method of claim 13, further including the step of rotating the tool about a tool rotation axis that is substantially perpendicular to the yaw axis.

20. The method of claim 1, further comprising the step of rotating the tool about an axis.

21. The method of claim 1, wherein the tool includes a yaw axis that is parallel to the tooth axis and wherein tool is not rotated about the yaw axis when the tool is translated along the first and second linear axes.

22. The method of claim 21, wherein the tool comprises a cutter.

23. The method of claim 1, wherein the tool comprises a grinding wheel.

24. The method of claim 1, wherein the tool comprises a milling tool.

25. The method of claim 1, wherein the tool comprises a cutter.

26. A method of producing a curved tooth comprising the steps of:
a) providing a workpiece;
b) providing a tool;
c) moving the tool through a tool path by rotating the tool about a path-defining axis to define a first curved surface of a tooth in the workpiece, wherein the first curved surface is defined about a first axis of curvature, and wherein the path-defining axis substantially extends along the first axis of curvature;
d) mapping deviations between the path-defining axis and the axis of curvature while moving the tool through the tool path; and
e) compensating for mapped deviations by modifying the tool path.

27. An apparatus for producing a curved tooth in a workpiece comprising:
a) a tool;
d) a device provided with instructions for providing relative movement between the tool and the workpiece such that the tool is capable of moving along a first curved path relative to the workpiece to define a first curved surface of a tooth in the workpiece, wherein the instructions assist in generating the first curved path by directing substantial simultaneous translation of at least one of the tool and the workpiece along a first linear axis and a second linear axis that is perpendicular to the first linear axis.

28. The apparatus of claim 27, wherein the instructions are capable of directing relative movement between the tool and the workpiece such that the tool is capable of moving along a second curved path relative to the workpiece to define a second curved surface of a tooth.

29. The apparatus of claim 27, wherein the instructions are capable of directing relative movement between the tool and the workpiece such that the tool is capable of moving along a second curved path relative to the workpiece that is a substantial mirror image of the first curved path.

30. The apparatus of claim 27, wherein the instructions are capable of directing relative rotation between the tool and workpiece about a yaw axis.

31. The apparatus of claim 30, wherein the tool includes a rotation axis that is substantially perpendicular to the yaw axis, wherein the tool is adapted to be rotated about the rotation axis.

32. The apparatus of claim 30, wherein the instructions are capable of directing the relative rotation as at least one of the tool and the workpiece is translated along the first and second linear axes.

33. The apparatus of claim 30, wherein the instructions are capable of substantially continuously providing the relative rotation while at least one of the tool and the workpiece is translated along the first and second linear axes.

34. The apparatus of claim 30, wherein the tool includes a machining surface and wherein the instructions are capable of directing the relative rotation to substantially maintain the machining surface along a plane that is tangent to the curved surface while the tool is defining the first curved surface of the tooth.

35. The apparatus of claim 30, wherein the device is capable of providing the relative rotation to minimize the interference between the tool and the tooth.

36. The apparatus of claim 27, wherein the tool includes a yaw axis and wherein the command does not direct the tool to be rotated about the yaw axis when the tool is translating along the first and second linear axes.

37. The apparatus of claim 36, wherein the tool comprises a cutter.

38. The apparatus of claim 27, wherein the tool comprises a grinding wheel.

39. The apparatus of claim 27, wherein the tool comprises a milling tool.

40. The apparatus of claim 27, wherein the tool comprises a cutter.

41. An apparatus for producing a curved tooth having a first curved surface defined about a first axis of curvature, the apparatus comprising:
a) a tool;
b) a device for moving the tool, wherein the device is provided with instructions for moving the tool through a tool path by rotating the tool about a path-defining axis to define a first curved surface of a tooth, wherein the device is adapted to map deviations between the path-defining axis and the axis of curvature while the tool is moving through the tool path, and wherein the device is adapted to compensate for the mapped deviations by modifying the tool path.
